(19) United States
(12) Patent Application Publication
(10) Pub. No.: US 2020/0300777 A1
(43) Pub. Date: Sep. 24, 2020

(54) METHOD AND DEVICE FOR INSPECTION OF THE SURFACE OF A MOVING SHEET

(71) Applicant: thyssenkrupp Rasselstein GmbH, Andemach (DE)

(72) Inventor: Jürgen KETT, Andernach (DE)

(73) Assignee: thyssenkrupp Rasselstein GmbH, Andernach (DE)

(21) Appl. No.: 16/823,478

(22) Filed: Mar. 19, 2020

(30) Foreign Application Priority Data
Mar. 20, 2019 (DE) 10 2019 107 174.7

(51) Int. Cl. G01N 21/86; G01N 21/88

(52) U.S. Cl. CPC G01N 21/86; G01N 2201/0648; G01N 2201/062; G01N 21/8803

(57) ABSTRACT

A method for inspection of a surface of a sheet moving in a direction, in which the surface is illuminated with first and second light sources, with the first light source emitting light under a first incidence angle range onto a first surface area and the second light source emitting light under a second incidence angle range onto a second surface area of the surface of the sheet. The first and second light sources are operated in pulsed fashion in alternation with a stipulated pulse frequency so that the surface of the sheet is illuminated in alternation with the pulse frequency in the first surface area and the second surface area and the first surface area illuminated by the first light source is observable by an inspector via a mirror in the bright field and the second surface area illuminated by the second light source is observable by the inspector via the mirror in the dark field.

### FIELD OF THE DISCLOSURE

The disclosure concerns a method and device for inspection by an inspector of the surface of a sheet moving in a sheet running direction.

### BACKGROUND

In the production of coated or uncoated steel sheets, for example, in auto making and in packaging applications, the surface of the sheet, which can be an uncoated or coated surface of a steel sheet, is examined by means of a surface inspection system in order to detect surface defects for purposes of quality control. The surface of a sheet coming from a production or refining process and moving with a sheet speed is then illuminated with light sources and monitored with cameras in order to record an image of the surface of the sheet. Such surface control of (coated or uncoated) steel sheets regularly occurs right after completion of a production, refining or coating process before the sheet is wound into a coil.

Numerous camera-based automatic surface inspection systems are known from the prior art with which detection and documentation and classification of surface defects can be automated.

The surface of a sheet being examined in the known surface inspection systems is illuminated with light sources, and the illuminated surface is recorded by one or more cameras in the bright field and/or dark field. To observe the sheet surface in the dark field, the cameras are then arranged with reference to the illuminated surface of the sheet so that the radiation directed from the light sources onto the sheet surface and reflected from it is refracted outside the observation field of the camera, in which case the radiation reflected or scattered on the surface defects is refracted in the direction of the camera in its observation field. Surface defects in the otherwise dark camera image are made recognizable on this account as bright spots (dark field observation). During bright field observation of the sheet surface the radiation directed from the light sources onto the sheet surface and reflected from it are directed toward the camera. A defect-free surface then generates a bright image in the camera. If a defect appears on the surface, part of the radiation is diffracted and diffusely scattered and therefore does not appear in the camera image. A surface defect here is expressed as a dark spot in the otherwise bright camera image (bright field observation).

Devices are known from the prior art, for example DE 197 20 308 A, in which observation of the surface being inspected occurs both in bright field and in dark field observation. Separate cameras are provided for this purpose for observation of the bright field and dark field, which are arranged in the emergent angle or outside the emergent angle of the light beams with reference to the radiation reflected from the surface. The images recorded by the cameras arranged in the bright field and dark field can be combined to produce an inspection image. It is then possible to detect almost all types of possible surface defects.

Despite automatic defect detection of surface defects using the known camera-based surface inspection systems, however, it is generally necessary that an inspector check the defects detected by the surface inspection system in order to evaluate whether the detected defect is actually present or can be tolerated or whether it is necessary to cut out the defective area of the sheet in order to eliminate the defect. This is due to the fact that not all defects are reliably detectable even with automated surface detection systems that observe the sheet surface both in the bright field and in the dark field. Final consideration by an inspector often occurs for this reason. Illumination devices are known from the prior art for this purpose with which the surface of a sheet being investigated by an inspector is illuminated as uniformly as possible so that an inspector can inspect the sheet surface in the running sheet with the human eye and examine it for defects.

The illumination systems known from the prior art that are used for (additional) inspection of a sheet by an inspector, however, often exhibit unduly nonuniform illumination of the sheet surface, for which reason the inspector cannot detect defects present in the insufficiently illuminated areas of the sheet surface. The illumination systems known from the prior art also often lead to blinding of the inspector. Blinding of the inspector has the result that surface defects, especially in excessively illuminated areas of the sheet surface, can be overlooked by the inspector. Blinding of the inspector also leads to rapid fatigue. Further drawbacks in the known illumination systems for inspection of sheet surfaces by an inspector lie in the fact that the known illumination systems are only arranged on one side of the sheet being inspected and the inspector therefore can only observe one sheet side.

### SUMMARY

Starting from this, one aspect of the disclosure relates to a method and device for inspection of the surface of a moving sheet by an inspector, with which glare-free observation of both sides of the sheet, if possible, is permitted, in which the sheet surface is illuminated as uniformly as possible over the entire sheet width so that the inspector can detect all defects on the surface of the sheet.

Preferred embodiments of the method and device are also disclosed.

In the method according to the disclosure for inspection by an inspector of the surface of a sheet moving in a sheet running direction, the surface of the sheet is illuminated with at least a first and a second light source, the first light source emitting a light beam under a first incidence angle range onto a first surface area and the second light source emitting a light beam under a second incidence angle range onto a second surface area of the sheet surface, in which case the first and second light source are pulsed in alternation with a stipulated pulse frequency so that the surface of the sheet is illuminated in alternation with the pulse frequency in the first surface area and the second surface area. The first surface area illuminated by the first light source is then observed by the inspector via a mirror in the bright field and the second surface area illuminated by the second light source is observed by the inspector via a mirror in the dark field.

A first and at least a second light source are provided in the device according to the disclosure, the first light source illuminating the surface of the sheet under a first incidence angle range in a first surface area and the second light source illuminating the surface of the sheet under a second incidence angle range in a second surface area and the first and second light source being pulsed in alternation with a stipulated pulse frequency so that the surface of the sheet is illuminated in alternation with the pulse frequency in the first and second surface area. For observation of the first and second surface area by an inspector at least one mirror is provided in the device according to the disclosure, which is arranged at a stipulated distance from the surface of the sheet and via which the inspector can observe the first surface area illuminated by the first light source in the bright field and the second surface area illuminated by the second light source in the dark field.

Using the device according to the disclosure and in the method according to the disclosure, it is possible for the inspector to observe both the bright field and the dark field of the sheet surface illuminated by the two light sources. For this purpose, the first and the second light source are operated in stroboscope manner with the stipulated pulse frequency so that the sheet surface is illuminated in alternation with the pulse frequency in the bright field and dark field from the perspective of the inspector. The first surface area of the sheet surface illuminated by the first light source then represents the bright field from the perspective of the inspector and the second surface area illuminated by the second light source represents the dark field, i.e., the radiation reflected from the first light source on the sheet surface is directed toward the inspector and the radiation reflected from the second light source on the sheet surface is directed away from the inspector. The light emitted from the first and second light sources onto the sheet surface is then preferably directed obliquely onto the sheet surface and expediently has an emission direction with a component across (perpendicular to) the sheet running direction. The first incidence angle range (Δ_{α1}) then preferably lies between 10° and 50° and the second incidence angle range (Δ_{α2}) preferably lies between 60° and 90°.

The inspector then observes both the bright field and the dark field of the sheet surface via a mirror, the viewing direction of the inspector preferably being directed across the sheet running direction. This permits glare-free observation and enables the inspector to observe the sheet surface at a sufficiently safe distance from the running sheet. This is advantageous for safety reasons and for noise protection reasons. Observation of the bright field and dark field by the inspector via a mirror also permits simultaneous observation of both sides of the sheet. For this purpose, it is prescribed in a preferred embodiment of the device according to the disclosure and in a preferred practical example of the method according to the disclosure that an equivalent device according to the disclosure is arranged both on the bottom of the sheet and on the top of the sheet.

It is prescribed in a further preferred practical example of the method according to the disclosure and the device according to the disclosure that the first surface area (bright field) at least partially overlaps the second surface area (dark field). This makes it possible for the inspector to detect at least in the overlapping area both surface defects that are visible only in the bright field and surface defects that are visible only in the dark field. Reliable detection of all types of surface defects by the inspector is made possible on this account.

In a particularly preferred practical example of the disclosure, a third and optionally a fourth light source is provided that emits light under a third or a fourth incidence angle range onto the surface of the sheet. The third or the fourth surface area of the sheet surface illuminated by the third and the optionally fourth light source is then observed by the inspector via a mirror in the dark field. The light beam directed from the third and the optionally fourth light source onto the sheet surface is then directed obliquely onto the sheet surface and has a component of the radiation direction in or against the sheet running direction. The area of the sheet surface illuminated by the third and the optionally fourth light source is observed by the inspector via a mirror in the dark field, the viewing direction of the inspector being directed across the sheet running direction. The inspector therefore sees the surface area of the sheet illuminated by the third and the optionally fourth light source in “convergent light”. This makes it possible for the inspector to recognize both bright field and dark field defects as well as convergent light defects on the sheet surface. The third and the fourth surface area, which is illuminated in convergent light (i.e., in the direction of the sheet running direction) by the third and the fourth light source on the sheet surface preferably at least partially overlaps the first surface area (bright field) and/or the second surface area (dark field), which is illuminated by the first and second light source.

The third light source, just like the first and second light source, is then operated in stroboscope manner, i.e., pulsed with a stipulated pulse frequency. It is particularly preferred to operate the first, second and third light source in succession in stroboscope manner with a stipulated pulse frequency so that the first, the second and the third surface area of the sheet is illuminated in alternation with light. When a fourth light source is used, which, like the third light source, is arranged in the “convergent light” (i.e., with a component of the radiation direction in or against the sheet running direction), this is preferably operated in step with the third light source.

The pulse frequencies with which the light sources are operated then expediently lie in the range of 70 Hz to 400 Hz. This range of pulse frequency permits fatigue-free work of the inspector. Observation of the sheet surface by an inspector is very tiring, especially at frequencies below 70 Hz. The preferred upper limit of 400 Hz for pulse frequency is primarily related to the apparatus, since signal processing with ordinary instruments is hampered at higher frequencies. The pulse length of the light pulse emitted from the light sources in stroboscope manner then preferably lies in the range of 30 μs to 100 μs.

The mirror, via which the inspector observes the surface areas of the sheet illuminated by the light sources, is expediently arranged above and/or below the sheet at a stipulated distance from the sheet surface, in which a reflection surface of the mirror (especially the mirror surface) preferably encloses with the surface of the sheet an angle in the range of 30° to 60° and especially an angle of 45°. Comfortable observation of the sheet surface by the inspector is guaranteed by this arrangement of the mirror or mirrors above or below the sheet. The inspector can then conduct the observation while standing or sitting, in which case the sheet expediently runs either in a horizontal plane or in a vertical plane.

Each of the light sources, i.e., the first and the second light source, as well as the optionally present third light source or any additional light source, expediently includes a number of LED light strips with several light-emitting diodes (LEDs) arranged at a spacing from each other. Each of the light sources can then comprise several LED light strips that are arranged at a limited spacing next to or one behind the other. A flat light source is produced by this preferred arrangement of several LED light strips. The light sources combined in this way from a plurality of LED light strips then preferably run parallel to the sheet surface, i.e., the first, the second and the optionally present third light source as well as any additional light source are arranged with reference to the sheet surface so that the LED light strips lie in a plane running parallel to the sheet surface.

Homogeneous illumination of the sheet surface is made possible by this structure and arrangement of the light sources. The illumination intensity (light intensity) required for optional illumination of the sheet surface can also preferably be adapted by dimmability of the individual LED light strips of the different light sources. Adjustment of the illuminated area to the width of the sheet can also occur by switching on or switching off individual LED light strips of the different light sources. An unnecessary blinding effect through unduly high illumination intensity or light intensity of the employed light sources can also be avoided by the dimmability and by switching on or switching off individual LED light strips.

Blinding of the inspector by the light sources can also be avoided in a preferred practical example of the disclosure by the fact that each LED light strip of each light source is equipped with a shutter (aperture) with which a visual field of the inspector relative to the LEDs of the LED light strip is covered. The speed of the shutter is then expediently adjustable to the visual field dependent on the observation position of the inspector. This permits glare-free observation of the sheet surface by the inspector in different observation positions.

### BRIEF DESCRIPTION OF THE DRAWINGS

These and additional advantages and features of the disclosure are apparent from the following practical example described below with reference to the accompanying drawings. The practical example then merely serves to explain the disclosure and is not to be viewed as restrictive for the scope of protection of the disclosure defined in the claims. The drawings show:

FIG. 1: Schematic view of a device for inspection of the surface of a sheet moving in a sheet running direction in a view in the sheet running direction;

FIG. 2: Depiction of the bright field generated by a first light source of the device of FIG. 1 on the surface of the bottom of the sheet;

FIG. 3: Depiction of the dark field generated by a second light source and an additional light source of the device of FIG. 1 on the top and bottom of the sheet;

FIG. 4: Schematic view of the device of FIG. 1 in a view perpendicular to the sheet running direction;

FIG. 5: Detailed view of the second light source of the device of FIG. 1;

FIG. 6: Detailed view of the first light source of the device of FIG. 1;

FIG. 7: Schematic view of an LED light strip used in the device of FIG. 1 to form the light sources.

### DETAILED DESCRIPTION

The device according to the disclosure and the method according to the disclosure can be used by an inspector to inspect the surface of the sheet moving at a stipulated sheet speed in a sheet running direction. The sheet, for example, can be an uncoated steel sheet (blackplate) or a coated steel sheet, like a zinc- or tin-plated steel sheet (tinplate). The sheet can also have on its surface an organic coating, for example, a paint layer or a polymer coating. The device according to the disclosure enables the inspector to detect surface defects on the surfaces of the sheet in the method according to the disclosure. If the inspector detects a defect, the running sheet can be stopped and the defective area in which the detected surface defect lies can be cut out from the sheet. The device according to the disclosure is then expediently arranged at the end of an installation for production or refining of the sheet and before a winding process for winding of the sheet into a coil.

The device according to the disclosure and the method according to the disclosure can then also be used in combination with a fully automatic surface inspection device, in which the device according to the disclosure is expediently arranged in the sheet running direction subsequent to the fully automatic surface inspection device. The device according to the disclosure and the method according to the disclosure then serve for additional inspection of the sheet surfaces, in addition to the fully automatic inspection by the surface inspection device. Certain surface defects cannot be detected fully or not precisely enough using the known automatic surface inspection devices in which cameras are used for imaging of the sheet surface. The device according to the disclosure and the method according to the disclosure enable an inspector to subject the defects detected by the fully automatic surface inspection device to further and especially more precise examination in order to decide whether the detected surface defect appears to require cutting out of the sheet area containing the defect.

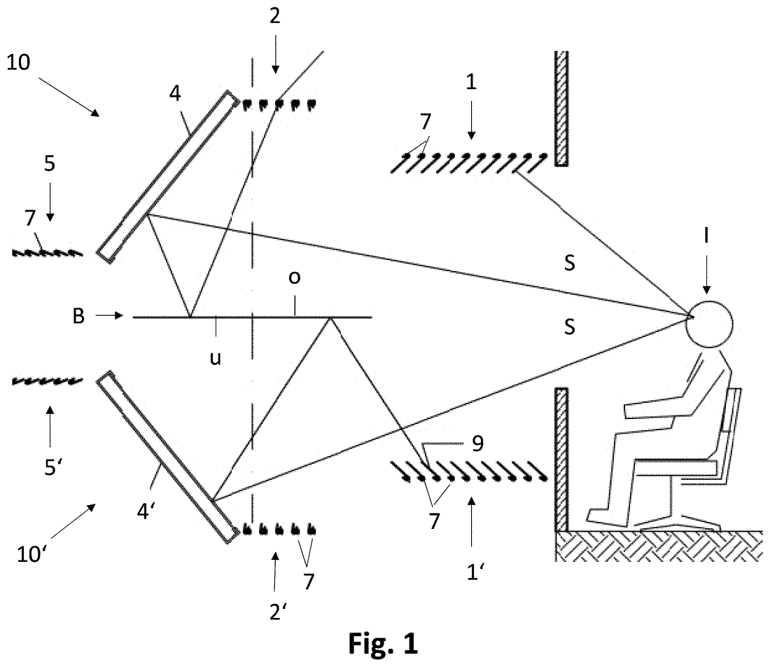

The device depicted in FIGS. 1 to 4 for inspection of the surface of a sheet B moving at a stipulated sheet speed in a sheet running direction v, includes a device 10, 10′ arranged on the sheet top o and on the sheet bottom u. Typical sheet speeds then lie in the range of 100 to 700 m/min. The sheet speed is then dependent on the speed with which the sheet is moved from a production or refining process, for example, a sheet coating installation.

The devices 10, 10′ depicted in FIG. 1 in a view in the sheet running direction v, which are arranged on the sheet top o and the sheet bottom u of the sheet B, include a first light source 1, 1′, a second light source 2, 2′ and an additional light source 5, 5′ as well as a mirror 4, 4′. The first light source 1, 1′ of each device 10, 10′ is then arranged offset laterally next to as well as above or beneath the sheet B. The second light source 2, 2′ is arranged above the sheet or under the sheet B at a distance to the corresponding sheet surface on the sheet top o or the sheet bottom u. The additional light source 5, 5′ is again arranged laterally offset and above or beneath the sheet B. The mirror 4 of the device 10 arranged above the sheet B has a mirror surface arranged at a stipulated angle to the surface of the sheet B. The mirror surface of mirror 4 encloses an angle in the range of preferably 30° to 60° and especially 45° with the plane of the sheet B (i.e., with the sheet surface). The mirror 4′ arranged beneath the sheet B of the device 10′ arranged on the sheet bottom u is correspondingly oriented relative to the surface of the sheet so that the mirror surface of mirror 4′ encloses an angle in the range of 40° to 60° and especially 45° with the sheet surface.

The light sources 1, 1′, 2, 2′ and 5, 5′ each emit light under a stipulated incidence angle range onto a surface of the sheet B, in which light sources 1, 2 and 5 of the device arranged above the sheet B emit light onto the sheet top o and the light sources 1′, 2′ and 5′ of the device 10′ arranged beneath the sheet B emit light onto the sheet bottom u. The sheet B illuminated by the light sources 1, 1′, 2, 2′ and 5, 5′ is observed by the inspector I via mirrors 4, 4′, in which mirror 4 of the upper device 10 permits observation of the sheet top o and mirror 4′ of the lower device 10′ permits observation of the sheet bottom u.

The light emitted from the first light source of the upper or lower device 10, 10′ onto the sheet surfaces is observed by the inspector I in the bright field. The light emitted by the first light source 1, 1′ and reflected on the corresponding sheet surface is deflected via mirror 4, 4′ into the visual field S of inspector I, for which reason the inspector I observes the area of the sheet surface illuminated by the first light source 1, 1′ in the bright field.

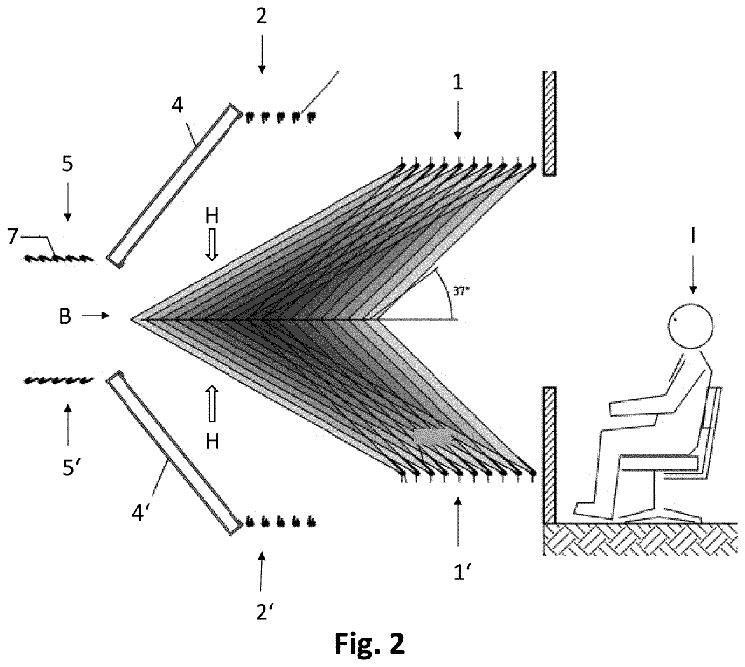

Illumination of the sheet surfaces by the first light source 1, 1′ in the bright field H is shown in FIG. 2. As is apparent from FIG. 2, the first light source 1, 1′ emits a light beam with a light cone stipulated by the employed light source under a stipulated first incidence angle α1 onto the sheet surfaces. The incidence angle α1 in the depicted example is α1=37°. A first incidence angle range Δα1=α1±Δ is defined by the incidence angle α1 and the beam angle range Δ of the light cone of the first light source. The beam angle range Δ of the employed light source then expediently lies between 10° and 20° and especially at Δ=15°.

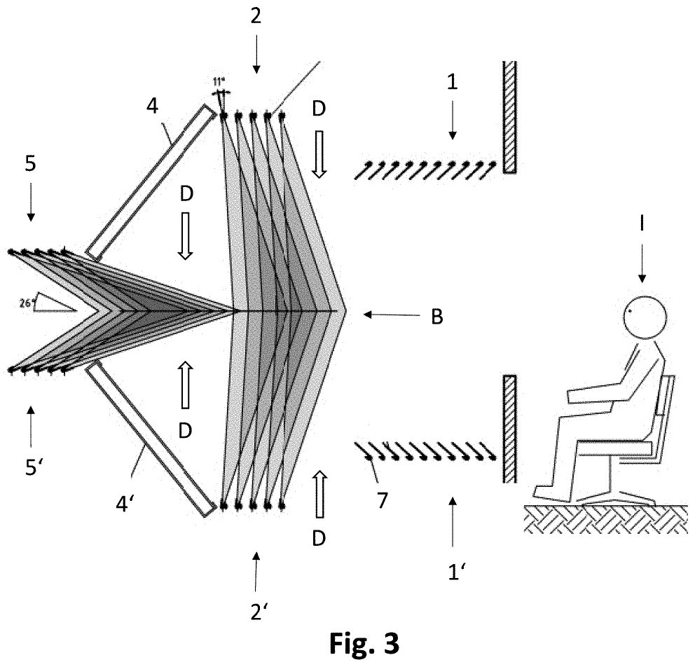

The dark field on the sheet surfaces generated by the second light source 2, 2′ and the additional light source 5, 5′ is shown in FIG. 3. The light beam directed from the second light source 2, 2′ and the additional light source 5, 5′ onto the sheet surfaces is back-reflected from the sheet surface and the corresponding mirror 4, 4′ from the visual field S of the inspector I, for which reason the inspector I sees the surface areas of the sheet B illuminated by the second light source 2, 2′ and the additional light source 5, 5′ in the dark field D. Illumination of the sheet surfaces with the second light source 2, 2′ and the initial light source 5, 5′ therefore enables the inspector I to observe the surfaces of the sheet B on the sheet top o and the sheet bottom u in the dark field.

As is apparent from FIG. 3, the second light source 2, 2′ emits a light beam with a light cone stipulated by the employed light source under a stipulated second incidence angle α2 onto the sheet surfaces. The incidence angle α2 in the depicted example amounts to α2=90°−11°=79°. A second incidence angle range Δa2=a2±Δ is defined by the incidence angle α2 and the beam angle range Δ of the light cone of the second light source 2, 2′. Accordingly, the additional light source 5, 5′ emits a light beam with a light cone stipulated by the employed light source under a stipulated incidence angle α5 onto the sheet surfaces. The incidence angle α5 in the depicted example amounts to α5=26°. An incidence angle range Δα5=α5±Δ is defined by the incidence angle α5 and the beam angle range Δ. As in the first light source, the beam angle range Δ of light sources 2, 2′ and 5, 5′ then expediently lies between 10° and 20° and especially at Δ=15°.

The incidence angles α1, α2 and α5 of the first light source 1, 1′, the second light source 2, 2′ and the additional light source 5, 5′ preferably lie in the following ranges:
30°≤α1≤45°
60°≤α2<90°
10°≤α5≤40°

The first light source 1, 1′, the second light source 2, 2′ and the additional light source 5, 5′ are then operated in alternation in stroboscope manner with a stipulated pulse frequency f so that the surface of the sheet B is illuminated in alternation with the pulse frequency f by the first light source 1, 1′ in the bright field (H) and by the second light source 2, 2′ in the additional light source 5, 5′ in the dark field (D). The inspector I can therefore observe both the bright field H and the dark field D of the sheet surfaces (in succession) with the pulse frequency f of the light sources. The pulse frequency f expediently lies in the range of 70 Hz to 400 Hz and preferably between 100 Hz and 300 Hz. The light pulses emitted from the light sources 1, 1′, 2, 2′ and 5, 5′ expediently have a stipulated pulse length tin the range of 30 μs to 100 μs and preferably between 50 μs and 80 μs. Because of the high pulse frequency f and the limited pulse lengths t the inspector I can conduct both bright field and dark field observation almost simultaneously on the running sheet B. This enables the inspector I to detect different surface defects that can be observed either only in the bright field or only in the dark field.

For this purpose, it is expedient if the surface area (dark field D) illuminated by the first light source 1, 1′ and the surface area (dark field D) illuminated by the second light source 2, 2′ and (optionally) by the additional light source 5, 5′ at least partially overlap on the corresponding sheet surface.

Each of the light sources 1, 1′, 2, 2′ and 5, 5′ depicted in FIG. 1 emit light under a stipulated incidence angle range and a stipulated beam direction onto the surface of the sheet B, the beam direction of the light sources then having a component across the sheet running direction v (i.e., perpendicular to the sheet running direction v) and a component directed perpendicular to the sheet surface.

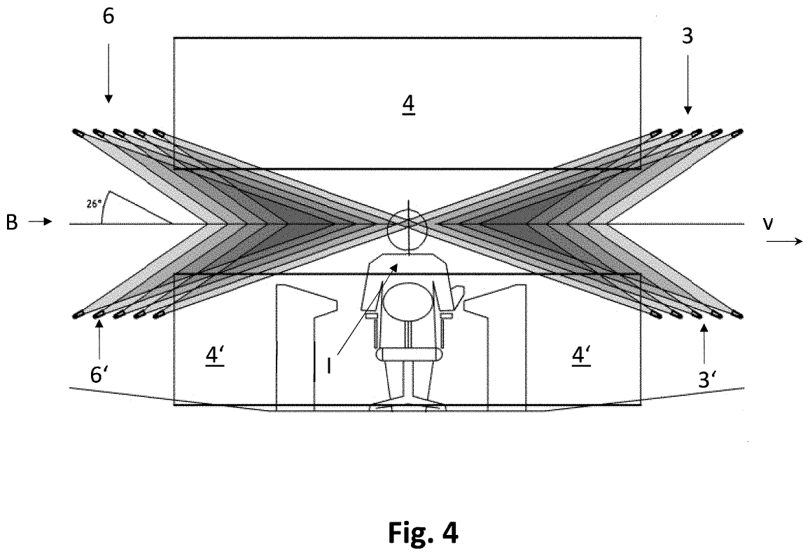

In addition to the light sources 1, 1′, 2, 2′ and 5, 5′ apparent from FIG. 1, additional light sources can also preferably be provided in the device according to the disclosure, in order to uniformly illuminate the sheet surfaces as well as possible. As is apparent from FIG. 4, a third light source 3, 3′ and a fourth light source 6, 6′ can be arranged above and beneath the sheet B, in which the third light source 3, 3′ emits light under a stipulated incidence angle range and a stipulated beam direction against the sheet running direction v onto the sheet surfaces. The incidence angle α3 of the third light source 3, 3′ and the optional fourth light source 6, 6′ in the depicted example amounts to α3=26° and preferably lies in the range of 10° to 40°. At a beam angle range Δ of the light cone of the third light source 3, 3′ and the fourth light source 6, 6′ a third incidence angle range Δα3=α3±Δ is defined.

The third light source 3, 3′ emits light under the stipulated incidence angle range Δα3 in a beam direction directed in the sheet running direction v onto the sheet surfaces. The fourth light source 6, 6′, on the other hand, emits light under the same incidence angle range Δα3 and in a beam direction directed against the sheet running direction v onto the sheet surfaces. The beam directions of the third light source 3, 3′ and the fourth light source 6, 6′ therefore contain a component directed in or against the sheet running direction v (as well as a component of the beam direction directed perpendicular to the sheet surface). The third light source 3, 3′ and the fourth light source 6, 6′ enable the inspector I to observe the surfaces on the sheet top o and the sheet bottom u in convergent light (i.e., with a beam direction having a component in or against the sheet running direction v). Because of this, additional surface defects can be observed that cannot be observed or only insufficiently observed in the bright field H or the dark field D.

Like the first, the second and the additional light sources 1, 1′; 2, 2′; 5, 5′, the third light source 3, 3′ and the fourth light source 6, 6′ are also operated in alternation with the first and second light sources in stroboscope manner with a stipulated pulse frequency and pulse length so that the areas illuminated by the light sources can be observed in alternation by the inspector I in the pulse frequency. The third light source 3, 3′ and the fourth light source 6, 6′ are then operated in pulsed fashion in step, i.e., the third light source 3, 3′ and the fourth light source 6, 6′ are simultaneously in step or out of step.

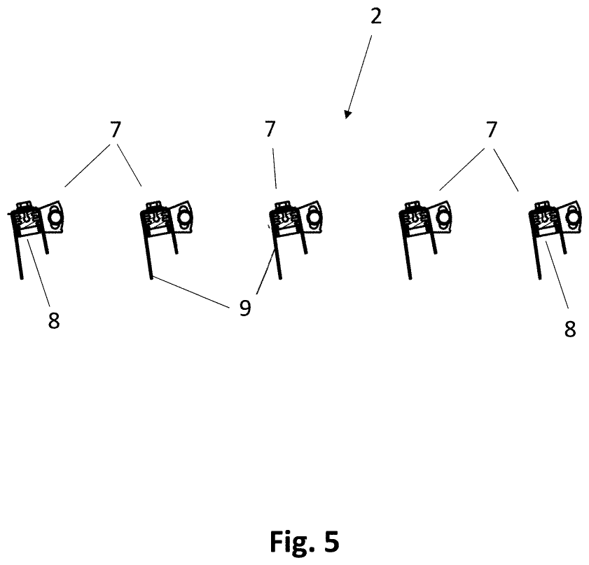

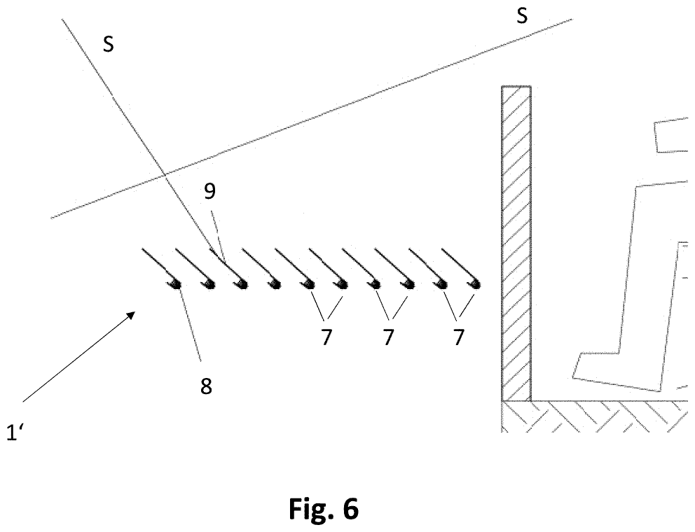

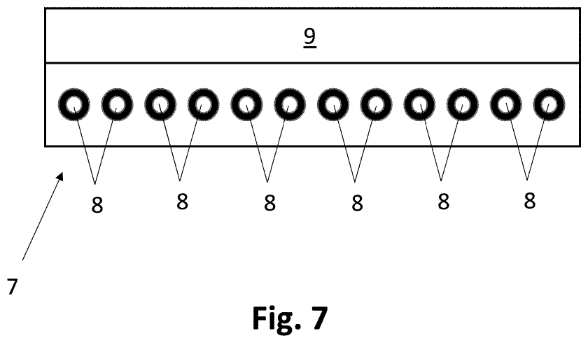

The light sources used in the device according to the disclosure are preferably formed by several LED light strips 7 arranged at a spacing next to and one after the other. In FIGS. 5 and 6 the second light source 2 arranged above the sheet top o and the first light source 1′ arranged beneath the sheet bottom u are shown in detail in a side view. The second light source 2 depicted in FIG. 5 includes five LED light strips 7 running parallel to each other and arranged one behind the other in the depicted practical example. Each of these five LED light strips 7 contains several light-emitting diodes (LEDs) 8 arranged at a spacing in the longitudinal direction of the LED light strip 7. Such an LED light strip having a total of 12 LEDs 8 is shown as an example in FIG. 7.

In order to avoid blinding of the inspector I, each LED light strip 7 preferably has a shutter 9, which is arranged in the visual field S of the inspector so that the inspector I cannot look either directly or indirectly via the mirror 4, 4′ into the light cone emitted by the LEDs 8. This is indicated in FIG. 6, where the edges of the visual field S of the inspector I are shown. As is apparent from FIG. 6, the shutters 9 of the LED light strips 7 cover the visual field S of the inspector I and in so doing prevent blinding of the inspector I. Glare-free and fatigue-free work of the inspector I is therefore permitted.

It is apparent from FIG. 1 that, by arranging the light sources in the form of several LED light strips 7 arranged one behind the other or next to each other, light sources designed flat are provided. The LED light strips 7 of the light sources then expediently run parallel to the sheet surface. The same also applies to the third light source 3, 3′ and the fourth light source 6, 6′. Through flat arrangement of the light sources a larger-area illumination of the sheet surfaces is made possible in the visual field S of the inspector I.

By switching on or switching off the individual LED light strips 7 of the individual light sources, areas of the sheet surface can then be switched to bright or dark. It is also possible to adjust the illuminated area of the sheet surfaces to the width of the sheet B by switching on or switching off the individual LED light strips 7 of the light sources.

The disclosure is not restricted to the depicted practical example. For example, it is not necessary to maintain the number and arrangement of light sources selected in the depicted practical example. It is sufficient according to the disclosure to merely illuminate the surface of the sheet B with a first and a second light source, in which the first light source illuminates a surface of the sheet in a bright field and the other light source illuminates the same surface of the sheet in a dark field, both light sources being operated in pulsed fashion in alternation with a stipulated pulse frequency so that the surface of the sheet is illuminated in alternation with the pulse frequency in the first surface area in the bright field and in the second surface area in the dark field of the observing inspector I.

It is also not essential according to the disclosure to arrange a device according to the disclosure both on the sheet top o and also the sheet bottom u. If the inspector I wishes to observe only one surface of the sheet B, for example, the sheet top o, it is sufficient if one device according to the disclosure is arranged only on the sheet top o. However, the disclosure makes possible simultaneous observation of both the surface on the sheet top o and on the sheet bottom u based on observation of the sheet surface by the inspector I via (at least) one mirror 4, 4′.

1. A method for inspection of at least one surface of a sheet moving in a sheet running direction by an inspector, in which the surface of the sheet is illuminated with a first light source and a second light source and in which the first light source emits light under a first incidence angle range onto a first surface area and the second light source emits light under a second incidence angle range onto a second surface area of the at least one surface of the sheet, the method comprising:
operating the first light source and the second light source in pulsed fashion in alternation with a stipulated pulse frequency so that the at least one surface of the sheet is illuminated in alternation with the pulse frequency in the first surface area and the second surface area and the first surface area illuminated by the first light source is observable by the inspector via a mirror in the bright field and the second surface area illuminated by the second light source is observable by the inspector via a mirror in the dark field.

2. The method according to claim 1, wherein observation of the first surface area and the second surface area occurs by human eye of the inspector without the aid of a camera.

3. The method according to claim 1, wherein the at least one surface includes both a bottom surface and a top surface of the sheet observed by the inspector, in which the first light source and the second light source are arranged to illuminate the top surface and third and fourth light sources are arranged to illuminate the bottom surface of the sheet.

4. The method according to claim 1, wherein the first surface area at least partially overlaps the second surface area.

5. The method according to claim 1, wherein a third surface area of the at least one surface of the sheet is illuminated by a third light source under a third incidence angle range and is observed by the inspector via the mirror in the dark field.

6. The method according to claim 5, wherein the light emitted by the third light source is pulsed and has a beam direction directed obliquely onto the at least one surface of sheet and the beam direction has a component in or against the sheet running direction.

7. The method according to claim 6, wherein the third surface area at least partially overlaps the first surface area and/or the second surface area.

8. The method according to claim 1, wherein the sheet is moved at a stipulated sheet speed, the pulse frequency being adjustable to the sheet speed.

9. A device for inspection of at least one surface of a sheet moving in a sheet running direction, with a first light source and a second light source, in which the first light source illuminates the at least one surface of the sheet under a first incidence angle range in a first surface area and the second light source illuminates the at least one surface of the sheet under a second incidence angle range in a second surface area and the first light source and the second light source are operated in pulsed fashion in alternation with a stipulated pulse frequency so that the at least one surface of the sheet is illuminated in alternation with the pulse frequency in the first surface area and the second surface area, and a mirror is arranged obliquely and at a distance to the at least surface of the sheet, via which the first surface area illuminated by the first light source and the second surface area illuminated by the second light source is observable by an inspector.

10. The device according to claim 9, wherein a reflection surface of the mirror includes an angle in the range of 30° to 60° to the at least one surface of the sheet.

11. The device according to claim 9, wherein a third light source, which emits light pulsed under a third incidence angle range onto a third surface area of the at least one surface of the sheet, in which the light emitted by the third light source has a beam direction directly obliquely onto the at least one surface of the sheet and the beam direction has a component in or against the sheet running direction.

12. The device according to claim 9, wherein the device is arranged for inspection of both a top surface and a bottom surface of the sheet.

13. The device according to claim 9, wherein the pulse frequency lies in the range of 70 Hz to 400 Hz.

14. The device according to claim 9, wherein the first light source and the second light source are operated in alternation in pulsed fashion in stroboscope manner with a stipulated pulse length in the range of 30 μs to 100 μs.

15. The device according to claim 9, wherein the first light source and the second light source includes a plurality of LED light strips having several LEDs arranged at a distance relative to each other.

16. The device according to claim 15, wherein the LED light strips of the first and the second light source are each arranged one behind the other in a direction running across the sheet running direction of the sheet, in which the light beam emitted by the first and the second light source includes a direction component running across the sheet running direction of the sheet.

17. The device according to claim 11, wherein each of the first, second, and third light sources includes a plurality of LED light strips having several LEDs arranged at a distance relative to each other with the LED light strip of the third light source arranged one behind the other in the sheet running direction of the sheet, in which the light beam emitted by the third light source includes a direction component running in or against the sheet running direction.

18. The device according to claim 17, wherein the LED light strip of each light source runs parallel at a stipulated spacing from the at least one surface of the sheet.

19. The device according to claim 17, wherein each LED light strip has a shutter that covers a visual field of the inspector to the LEDs of the light strip and in so doing prevents blinding of the inspector.

20. The device according to claim 17, wherein the individual LED light strips of the plurality of LED light strips of each light source can be switched on and switched off independently of the other LED light strips.

21. The device according to claim 9, wherein the first incidence angle range lies between 10° and 50° and/or the second incidence angle range lies between 60° and 90°.
